(19) United States
(12) Patent Application Publication
(10) Pub. No.: US 2025/0361382 A1
(43) Pub. Date: Nov. 27, 2025

(54) COMPOSITION FOR LENS AND CAMERA MODULE LENS COMPRISING THE SAME

(71) Applicants: Samsung Electro-Mechanics Co., Ltd., Suwon-si (KR); UNIVERSITY-INDUSTRY COOPERATION GROUP OF KYUNG HEE UNIVERSITY, Yongin-si (KR)

(72) Inventors: Seong Chan PARK, Suwon-si (KR); Eun Jung LIM, Suwon-si (KR); Ji Sung CHOI, Suwon-si (KR); Jee Woo LIM, Seoul (KR); Soo Hye PARK, Seoul (KR)

(73) Assignees: Samsung Electro-Mechanics Co., Ltd., Suwon-si (KR); UNIVERSITY-INDUSTRY COOPERATION GROUP OF KYUNG HEE UNIVERSITY, Yongin-si (KR)

(21) Appl. No.: 19/035,165

(22) Filed: Jan. 23, 2025

(30) Foreign Application Priority Data
May 23, 2024 (KR) 10-2024-0067030

(51) Int. Cl. C08K 5/524; C08L 69/00; G02B 1/04

(52) U.S. Cl. CPC C08K 5/524; C08L 69/00; G02B 1/041

(57) ABSTRACT

A composition for a lens includes a resin, and an antioxidant of phosphorus, wherein the antioxidant has a chemical structure of

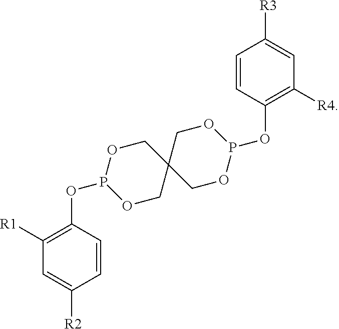

### CROSS-REFERENCE TO RELATED APPLICATIONS

This application claims the benefit under 35 USC 119(a) of Korean Patent Application No. 10-2024-0067030 filed on May 23, 2024, in the Korean Intellectual Property Office, the entire disclosure of which is incorporated herein by reference for all purposes.

### BACKGROUND

### 1. Field

The present disclosure relates to a composition for a lens and a camera module lens comprising the same.

### 2. Description of the Background

With the commercialization of electric vehicles and the development of autonomous driving, the camera market for an Advanced Driver Assistance System (ADAS), the basis of autonomous driving, is expanding.

Since vehicle cameras require a much higher level of precision and reliability than mobile cameras, glass has been used as the lens material for battlefield cameras due to its excellent thermal stability.

However, recently, attempts have been made to develop hybrid lenses replacing some glass lenses with plastic lenses to reduce the weight of a product and improve profitability, but to achieve this, the issue of thermal stability of the plastic lens material must be resolved.

Plastic materials easily undergo oxidation reactions on a surface when in contact with air.

In addition, during an extrusion and molding process of plastic materials, alkyl radicals may be generated by heat and mechanical shear force, etc., and may react immediately with oxygen to form peroxide radicals, and the peroxide itself decomposes and reacts with other polymer molecules, which is known as an auto-oxidation reaction.

This type of auto-oxidation reaction continues until a stable compound is created, which changes the properties of the plastic material.

Antioxidation methods for suppressing or preventing such oxidation deterioration reactions include methods for inhibiting chain growth reactions and methods for decomposing peroxides.

An antioxidant that has the effect of capturing generated radicals and preventing a progression of the radical chain reaction is known as a radical chain inhibitor, and an antioxidant having the effect of decomposing generated hydroperoxide into a form that does not generate radicals is known as a peroxide decomposer.

Polymeric phenol antioxidants and amine antioxidants are mainly used as chain inhibitors, and phenol antioxidants and amine antioxidants may cause discoloration problems.

When the main ingredient is a synthetic resin such as polycarbonate, discoloration may occur more easily in the case of amine-based antioxidants due to the high temperatures used during processing.

Sulfur antioxidants and phosphorus antioxidants may be used as peroxide decomposers.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a composition for a lens includes a resin, and an antioxidant of phosphorus, wherein the antioxidant has a chemical structure of

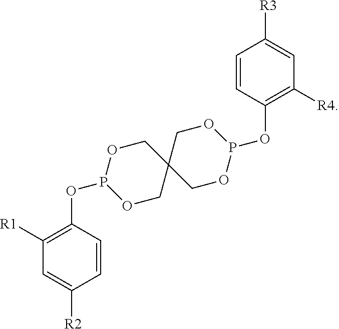

The antioxidant may have a molecular weight (Mw) of 500 or more and a melting point (MP) of 150 to 280° C.

The antioxidant may include an amount of 0.001 wt. or more and less than 5.0 wt. based on 100 wt. of a total composition.

The antioxidant may include a molecular weight (Mw) of 500 or more and a melting point (MP) of 150 to 280° C., and the antioxidant may include an amount of 0.001 wt. or more and less than 5.0 wt. based on 100 wt. of a total composition.

The composition may further include a phenolic antioxidant.

The antioxidant may have a molecular weight (Mw) of 500 or more and a melting point (MP) of 150 to 280° C.

The antioxidant of phosphorus may include an amount of 1 to 1000 wt. per 100 wt. of the phenol antioxidant.

The resin may be a polycarbonate.

The polycarbonate may have a Bisphenol A (BPA) structure.

The polycarbonate may have a fluorene structure.

A camera module lens may include the lens composition described herein.

Other features and aspects will be apparent from the following detailed description, the drawings, and the claims.

### BRIEF DESCRIPTION OF DRAWINGS

FIG. 1 is a perspective view schematically illustrating a lens according to an embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the FIGURES is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

A lens composition according to an embodiment of the present disclosure comprises a resin and an antioxidant.

The resin may be polycarbonate.

Additionally, polycarbonate may be composed of either a fluorene structure having a chemical structure of Chemical Formula 1 or a BPA (Bisphenol A) structure having a chemical structure of Chemical Formula 3, or may be composed of a heterogeneous mixture of the two.

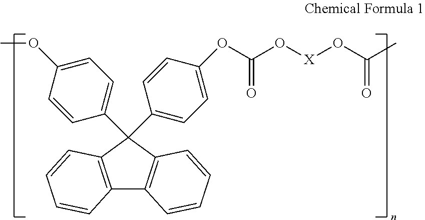

Here, a functional group that may control a glass transition temperature or control a refractive index and hygroscopicity may be introduced into an X group.

This functional group X may have a structure as in Chemical Formula 2, and the present disclosure may not be limited thereto.

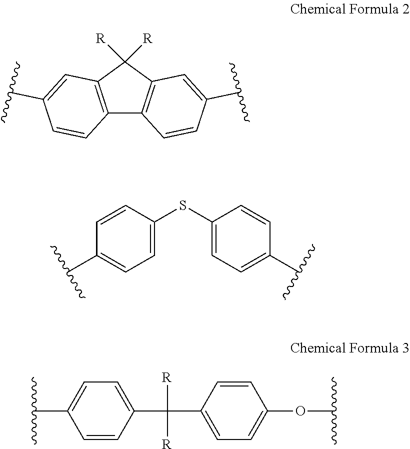

A functional group that may control the glass transition temperature or control the refractive index and hygroscopicity may be introduced into an R group.

This functional group R may have a structure such as Chemical Formula 4, but the present disclosure may not be limited thereto.

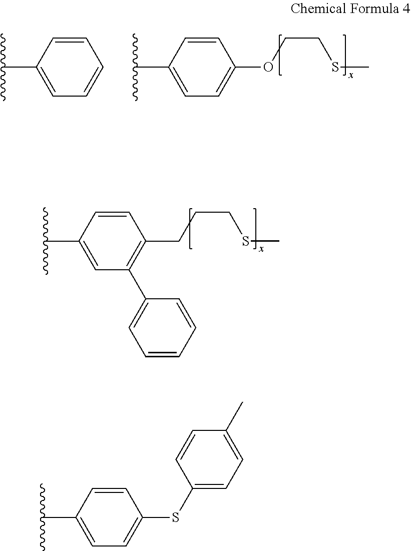

The antioxidant may include at least one phosphorus antioxidant having excellent high-temperature stability.

Here, if the melting point (MP) of the antioxidant may be less than 150° C., a defect occurrence rate increases during a high-temperature reliability test because the change at high temperatures may be large.

In addition, when analyzing the resin, FD-MS analysis of a captured gas is performed for 10 minutes at 280° C., which may be the injection processing temperature, and Pyrolyzer-GC analysis is performed at 120° C., which may be the high-temperature reliability condition. The molecular weight (Mw) of the additives detected in the analysis results of the outgas may be mainly compounds with a molecular weight of less than 500.

When the molecular weight of the antioxidant is less than 500 or the MP is less than 150° C., the amount of outgas released may be excessively large under the injection processing temperature of the composition and the temperature conditions of high-temperature reliability, which may cause defects such as bubbles or discoloration in a molded product, thereby deteriorating the optical properties.

In addition, as the thermal stability of the composition deteriorates, it may be no longer possible to expect the effect of suppressing or preventing changes in the transmittance, refractive index, and birefringence of the lens after heat treatment.

Therefore, in an embodiment, the molecular weight (Mw) of the phosphorus antioxidant may be 500 or more, and the MP may be 150 to 280° C. Here, the MP may be measured using a thermal analyzer.

The phosphorus antioxidant may have a structure of Chemical Formula 5.

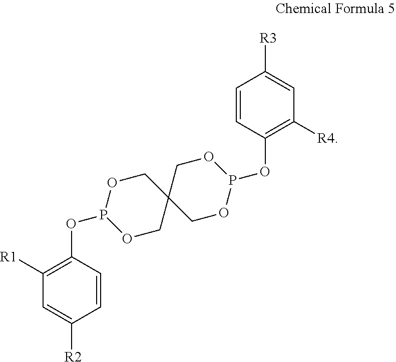

The phosphorus antioxidant may decompose hydroperoxide to suppress the yellowing of polymers and provide the effect of suppressing changes in refractive index and birefringence.

Unlike Chemical Formula 5, in a case of phosphite with only alkyl groups connected, thermal decomposition and hydrolysis may occur more easily than aryl phosphite, which may reduce the duration of the effect.

Here, in Chemical Formula 5, R1, R2, R3, and R4 may each be a C1-C25 alkyl, alkenyl, butyl, or phenyl group, and may also be substituted with a halogen, hydroxy, thiol, or amino group.

In the case of having detailed substituents, it may have excellent compatibility with polymer materials, so it may be uniformly mixed with various optical polymer materials, and may have the effect of suppressing phase separation between polymers and antioxidants.

If the substituent has a high hydrophilicity, problems with moisture absorption and compatibility with highly hydrophobic optical polymers may occur, and the durability of the antioxidant effect may be reduced due to hydrolysis.

Here, the phosphorus antioxidant may be included in an amount of 0.001 wt. or more and less than 5.0 wt. based on 100 of the total weight of the composition.

If the content of the antioxidant is less than 0.001 wt %, the antioxidant effect is insufficient, and the effect of improving the thermal stability of the composition according to an embodiment of the present disclosure may not be properly implemented.

In addition, if the content of the phosphorus antioxidant is 5.0 wt. or more, the Tg (glass temperature) of the resin included in the composition may decrease due to plasticization of the polymer material, which may cause a problem in that the thermal stability of the composition may decrease. Here, Tg may be measured using a thermal analyzer.

Here, the components and content of the antioxidant may be confirmed by extracting the additive using the Soxhlet extraction method, microwave method, solvent-dissolved polymer precipitation method, etc., and then separating each component and conducting a qualitative and quantitative analysis.

For example, the spectrum of a Soxhlet extract of a resin composition of an embodiment is measured by field deionization mass spectrometry (FD-MS), and a molecular ion peak estimated to be a phosphorus antioxidant is detected together with a polycarbonate component extracted from the spectrum to determine a quantification.

Then, the additive components purified by FD-MS may be qualitatively and quantitatively analyzed by liquid chromatography (LC) and gas chromatography (GC). The content and molecular weight of the phosphorus antioxidant may be obtained by comparing the retention time and peak area with a chromatogram, which may be a standard for various additives.

In addition, the oxidation status of the phosphorus antioxidant may be identified by 31P-NMR (Nuclear Magnetic Resonance), and the Chemical Formula (structural formula) of the phosphorus antioxidant may be confirmed by linking FD-MS and 31P-NMR.

Hereinafter, the ingredients, content, and Chemical Formula of each antioxidant described may be confirmed through the same process as the above method.

Meanwhile, as oxidation prevention methods for suppressing or preventing oxidation deterioration reactions, there may be methods for inhibiting chain growth reactions and methods for decomposing peroxides.

An antioxidant having the effect of capturing the generated radicals and preventing the progression of the radical chain reaction is known as radical chain inhibitors, and an antioxidant having an effect of decomposing the generated hydroperoxide into a form not generating radicals is known as a peroxide decomposer.

As chain inhibitors, polymer-type phenol antioxidants and amine antioxidants may be mainly used. The phenol antioxidants and the amine antioxidants, which are chain inhibitors, may cause discoloration problems, especially, when the main component is a synthetic resin such as polycarbonate, discoloration may occur more easily in the case of amine antioxidants due to high temperatures during processing.

Sulfur-based antioxidants and phosphorus-based antioxidants are used as peroxide decomposers, and although their antioxidant effect may be lower than that of phenol-based antioxidants, they may not have discoloration problems and may be therefore used to reduce or eliminate the discoloration problem of chain inhibitors.

Phenolic antioxidants may have excellent antioxidant effects, but they may have a problem of yellowing in certain environments containing NOx gas.

In an embodiment, a phosphorus antioxidant having a molecular weight of 500 or more and an MP of 150 to 280° C. may serve to complement the coloration problem of such phenolic antioxidants.

Although the combined effect of the phosphorus antioxidant may be lower than that of the sulfur antioxidant, it may have a superior heat resistance effect at high temperatures, so it may have the advantage of being stable at high temperatures when processing polycarbonate materials that may be used in the manufacture of camera module lenses to which the composition of an embodiment is applied.

In addition, phosphorus-based antioxidants may prevent the yellowing problem of sulfur-based antioxidants.

Here, ultra-high molecular weight phenol (HMW Phenolic) and organophosphite antioxidants may be used in a certain ratio depending on the form, and the type and length of detailed substituent affect the compatibility of the polymer and other additives, therefore the type of antioxidant and the added content are important.

Accordingly, a ratio of the phenol-based antioxidant and the phosphorus-based antioxidant may be such that the phosphorus-based antioxidant is included in an amount of 1 to 1000 wt. per 100 wt. of the phenol-based antioxidant.

If the content of the phosphorus antioxidant is less than 1 wt. per 100 wt. of the phenol antioxidant, the anti-oxidation effect may be insufficient, and the effect of improving the thermal stability of the composition according to the present disclosure may not be properly implemented.

If the content of the phosphorus antioxidant exceeds 1000 wt. per 100 wt. of the phenol antioxidant, the antioxidant effect is insufficient compared to the amount added, and the plasticization of the polymer composition is intensified, which may cause a problem in that the Tg of the resin included in the composition is lowered, thereby lowering the thermal stability of the composition.

A lens composition configured in this manner may be made into various embodiments as follows.

A lens composition of Example 1 comprises a resin having a fluorene structure, and an antioxidant comprising a phenol-based antioxidant and a phosphorus-based antioxidant.

Here, the resin may be the first polycarbonate having the fluorene structure having a Tg of 162° C.

Also, the phenol antioxidant may be Pentaerythritol Tetrakis[3-(3,5-di-tert-butyl-4-hydroxyphenyl)propionate] having a structure of Chemical Formula 6, and the phosphorus antioxidant may be 3,9-Bis(2,4-di-tert-butylphenoxy)-2,4,8,10-tetraoxa-3,9-diphosphaspiro[5,5]undecane having a structure of Chemical Formula 7.

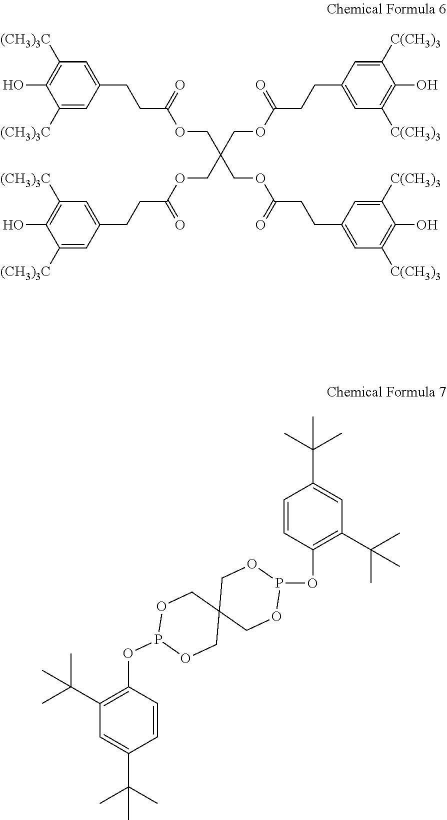 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O ; CC(C)(C)c1ccc(OP2OCC3(CO2)COP(Oc2ccc(C(C)(C)C)cc2C(C)(C)C)OC3)c(C(C)(C)C)c1]

Here, the phenol antioxidant may have a molecular weight of 1178 and an MP of 115° C., and the phosphorus antioxidant may have a molecular weight of 604 and an MP of 177° C.

A lens composition of Example 2 comprises a resin having a fluorene structure, and an antioxidant comprising a sulfur-based antioxidant and a phosphorus-based antioxidant.

Here, the resin may be a second polycarbonate having a fluorene structure having a Tg of 158° C.

And, the sulfur-based antioxidant may be Dioctadecyl 3,3′-Thiodipropionate having a structure of Chemical Formula 8, and the phosphorus-based antioxidant may be 3,9-Bis(2,4-di-tert-butylphenoxy)-2,4,8,10-tetraoxa-3,9-diphosphaspiro[5,5]undecane having a structure of Chemical Formula 7.

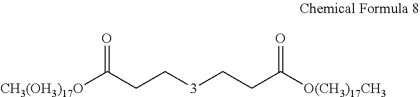

Here, the sulfur-based antioxidant may have a molecular weight of 683 and an MP of 65° C., and the phosphorus-based antioxidant may have a molecular weight of 604 and an MP of 177° C.

When a lens is manufactured using a lens composition having such a configuration, changes in the transmittance and refractive index of the lens under high-temperature heat treatment conditions may be prevented.

Therefore, by improving the thermal stability of optical properties such as transmittance, refractive index, and birefringence of the lens during high-temperature processing and high-temperature reliability evaluation, it may be applied as a lens material for high-precision, high-reliability products such as battlefield camera modules.

### Camera Module Lens

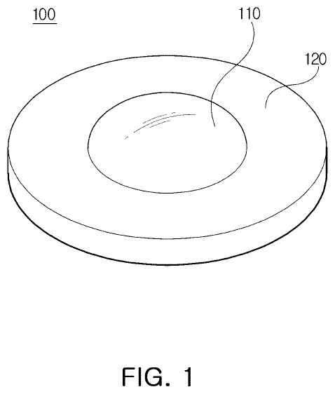

As illustrated in FIG. 1, a lens (100), e.g., a camera lens, according to an embodiment of the present disclosure includes an optical portion (110) and a rib portion (120) extending outward in a radial direction (Y) of the optical portion (110).

Here, the radial direction (Y) may mean a direction from the center of the optical portion (110) toward the outer surface of the lens (100), and may mean a direction perpendicular to an optical axis direction (Z).

The lens (100) of an embodiment may be a plastic resin lens manufactured by molding the lens composition described above into a predetermined shape using a mold or the like, and the lens manufacturing method of the present disclosure may not be limited to this method.

The optical portion (110) may be a region in which the optical performance of the lens (100) is demonstrated, and may be, for example, a region in which light reflected from an object (or subject) is refracted.

The rib portion (120) may be a region securing the lens (100) to another component, such as a lens barrel, another lens, and/or a spacer.

The optical portion (110) and the rib portion (120) are distinguished by their positions and functions, and mean distinct region within a single lens (100), and in an embodiment, the lens (100) may be integrated with the optical portion (110) and the rib portion (120).

The lens (100) may contain 0.001 wt. or more and less than 5.0 wt. of a phosphorus antioxidant based on the total weight of the lens (100).

If the content of the phosphorus antioxidant is less than 0.001 wt., the anti-oxidation effect is insufficient, and the effect of improving the thermal stability of the lens cannot be properly implemented. If the content of the phosphorus antioxidant is 5.0 wt. or more, the glass transition temperature (Tg) of the composition decreases by more than 15° C. due to the plasticizing effect, which may result in a decrease in thermal numerical stability and vulnerability to thermal deformation.

A lens composed in this manner may use polycarbonate as a component, and may provide excellent transparency and durability, while also improving the stability of optical properties such as transmittance, refractive index, and birefringence in high-temperature environments, thereby increasing the freedom of molding conditions and allowing for improvements in reliability and precision.

### EXPERIMENTAL EXAMPLES

Heat treatment tests measure changes in appearance, changes in refractive index, and changes in birefringence.

Here, the heat treatment conditions for observing the appearance change may be 300° C. for 30 minutes, and the measurement of the change in refractive index and birefringence may be performed by drop-casting THF at a concentration of 100 mg/ml of resin on a Si wafer and measuring it after heat treatment at 100° C. for 48 hours.

Comparative Example 1 is composed of only the first polycarbonate without an antioxidant. Comparative Example 2 includes the first polycarbonate and 1 wt. of a phenol-based antioxidant relative to 100 wt. of the first polycarbonate. An embodiment Example 1 includes the first polycarbonate and 1 wt. of a phosphorus-based antioxidant relative to 100 wt. of the first polycarbonate.

Here, the first polycarbonate may have a fluorene structure containing a methyl group or an alkyl group. For example, the first polycarbonate may be 9,9-Bis(4-hydroxy-3-methylphenyl) fluorene having the structure of a Chemical Formula 9 below.

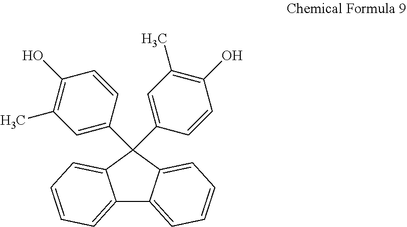 [SMILES: Cc1cc(C2(c3ccc(O)c(C)c3)c3ccccc3-c3ccccc32)ccc1O]

As a result of a test, in the case of Comparative Example 1 that does not contain an antioxidant, yellowing occurred and the appearance changed significantly. In the case of Comparative Example 2 containing a phenol-based antioxidant, yellowing occurred although not as severe as in Comparative Example 1, and in the case of Example 1, no yellowing occurred.

Looking at the change in refractive index @633 nm, it was +0.0032 for Comparative Example 1, −0.0043 for Comparative Example 2, which was higher than Comparative Example 1, and 0.003 for Example 1, which was lower than Comparative Example 1.

Looking at the change in birefringence at @633 nm, it was +0.0011 for Comparative Example 1, −0.0015 for Comparative Example 2, which was higher than Comparative Example 1, and −0.0007 for Example 1, which was lower than Comparative Example 1.

Therefore, it may be seen that in the lens composition of Example 1 containing the first polycarbonate resin as a main component, if a phosphorus antioxidant is included, yellowing may be prevented while suppressing changes in the refractive index and birefringence of the lens.

Comparative Example 3 includes 1 wt. of a sulfur-based antioxidant per 100 wt. of the second polycarbonate and the second polycarbonate, and an embodiment Example 2 includes 1 wt. of a phosphorus-based antioxidant per 100 wt. of the second polycarbonate and the second polycarbonate.

Here, the second polycarbonate may have a fluorene structure. For example, the second polycarbonate (C41H34O4) may be 2,2′-(((9H-fluorene-9,9-diyl)bis([1,1′-biphenyl]-5,2-diyl))bis(oxy)) diethanol having a structure of Chemical Formula 10 below.

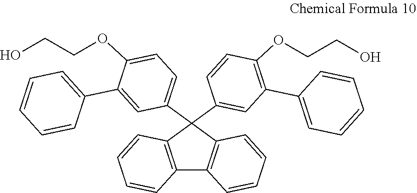 [SMILES: OCCOc1ccc(C2(c3ccc(OCCO)c(-c4ccccc4)c3)c3ccccc3-c3ccccc32)cc1-c1ccccc1]

As a result of the test, in the case of Comparative Example 3 containing a sulfur-based antioxidant, yellowing occurred and the appearance was severely changed after heat treatment, while in the case of embodiment Example 2 containing a phosphorus-based antioxidant, yellowing did not occur.

Here, looking at the change in refractive index at @633 nm, in the case of Comparative Example 3, the change in refractive index was +0.0106 and the change in birefringence was −0.0001.

Also, the refractive index of embodiment Example 2 at @633 nm may be found to change by +0.0178, and the change in birefringence may be found to be +0.0009.

Therefore, it may be seen that Comparative Example 3, which includes a sulfur-based antioxidant, may have less change in refractive index and birefringence than embodiment Example 2, but Comparative Example 3 may not be used for lenses because appearance defects occur after heat treatment.

Meanwhile, when comparing embodiment Example 1 and embodiment Example 2, the refractive index change and birefringence change in embodiment Example 1 are relatively small.

Accordingly, when using fluorene series as a resin, it may be seen that a fluorene structure containing a methyl group or alkyl group is more advantageous in preventing changes in refractive index and birefringence.

According to an embodiment in the present disclosure, there is an effect of preventing thermal oxidation of a lens by suppressing changes in transmittance and refractive index under heat treatment conditions, thereby improving the thermal stability of a lens.

In addition, according to an embodiment of the present disclosure, a camera module lens may be manufactured that suppresses yellowing and has high thermal stability in optical properties compared to a phenol-based antioxidant.

An aspect of the present disclosure is to provide a composition for a lens and a camera module lens including the same, capable of improving the thermal stability of a lens by preventing thermal oxidation of the lens by suppressing or preventing changes in transmittance and refractive index under heat treatment conditions.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A composition for a lens, the composition comprising:
a resin; and
an antioxidant of phosphorus,
wherein the antioxidant has a chemical structure of

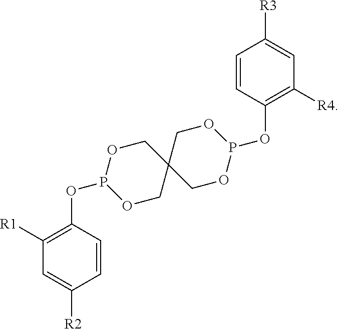

2. The composition of claim 1, wherein the antioxidant has a molecular weight (Mw) of 500 or more and a melting point (MP) of 150 to 280° C.

3. The composition of claim 1, wherein the antioxidant is included in an amount of 0.001 wt. or more and less than 5.0 wt. based on 100 wt. of a total composition.

4. The composition of claim 1, wherein the antioxidant has a molecular weight (Mw) of 500 or more and a melting point (MP) of 150 to 280° C., and
wherein the antioxidant is included in an amount of 0.001 wt. or more and less than 5.0 wt. based on 100 wt. of a total composition.

5. The composition of claim 1, further comprising a phenolic antioxidant.

6. The composition of claim 5, wherein the antioxidant has a molecular weight (Mw) of 500 or more and a melting point (MP) of 150 to 280° C.

7. The composition of claim 5, wherein the antioxidant is included in an amount of 1 to 1000 wt. per 100 wt. of the phenol antioxidant.

8. The composition of claim 1, wherein the resin is a polycarbonate.

9. The composition of claim 8, wherein the polycarbonate has a Bisphenol A (BPA) structure.

10. The composition of claim 8, wherein the polycarbonate has a fluorene structure.

11. A camera module lens comprising the lens composition of claim 1.
